(19) United States
(12) Patent Application Publication
(10) Pub. No.: US 2006/0283505 A1
(43) Pub. Date: Dec. 21, 2006

(54) Liquid flow control system

(76) Inventors: Ted J. Makowan, Schaumburg, IL (US); Alan G. VandenBerg, Naperville, IL (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/157,070

(22) Filed: Jun. 20, 2005

(51) Int. Cl. F16K 31/18

(52) U.S. Cl. 137/388

(57) ABSTRACT

A system is provided for controlling flow of air and preventing flow of liquid within vent lines connected to, for example, a pipe line or other like piping systems. The system has a first float in a first body and a second float in a second body. The first body has an open flanged top end, a flanged bottom end with an inlet therethrough and an interior wall defining an open interior. The second body also has an open flanged top end arranged to mate with said flanged bottom end of said first body, a bottom end, an interior wall defining an open interior and an inlet into the open interior. In an embodiment, the first body and the second body are identical in size, shape and configuration. A cover is arranged to engage the top end of the first body and it has an outlet formed therethrough. A first seat is secured at the outlet in the cover to define an outlet for the first body. A second seat is secured at the inlet of the first body to define an outlet for the second body. The floats are capable of moving into and out of engagement with their respective seats due to a level of liquid in the interior of the respective body.

### BACKGROUND OF THE INVENTION

The present invention generally relates to venting, exhaustion and/or admission of air in piping systems. More specifically, the present invention relates to a system and a method for controlling the entrance of water into a pipeline and its associated venting system when an area surrounding the same is flooded.

It is, of course, generally known to provide check valves. For example, a floatable check valve is disclosed in U.S. Pat. No. 3,620,240 to Bogdanski. Bogdanski discloses a double check valve vent in which floatable valves are positioned in a vent line to be floated up against a valve seat when fluid flows outwardly from the tank or flows inwardly toward the tank. The floatable valves, in the absence of fluid, are each spaced a substantial distance from their respective seats so that fumes venting from the tank may move freely with a complete absence of back pressure.

The vent pipe of Bogdanski is particularly applicable for use with fuel tanks on boats wherein it is important to prevent the flow of water through the vent line into the fuel tank to prevent the flow of gasoline or fuel oil out of the vent line and onto the boat where it potentially may present a fire hazard.

However, the arrangement illustrated by Bogdanski has its drawbacks. First, the arrangement is designed for routine venting of a tank and does not provide the flow capacity or characteristics needed for protecting piping systems from over and under pressurization. The valve also lacks sealing features to positively prevent the entrance of outside fluid. Therefore, the check valve has limited adaptability for various applications.

A system and a method including an air/vacuum valve, air release valve or combination-type air valve having a liquid flow control device is provided in U.S. Pat. No. 5,613,513. The float disclosed in that patent includes a plunger, which is used to maintain a desired orientation of the float in the valve body. A drawback associated with such plungers exists in cold weather installations wherein ice or frost may form in the valve body, locking the plunger to its guide, and preventing the float from moving up and down.

A liquid flow control device is disclosed in U.S. Pat. No. 5,613,513, which requires the use of a plunger to guide a float within a body. In situations where the liquid flow control device is subject to below freezing temperatures, such as outdoor and underground use in northern climates, ice or frost could form on the plunger and prevent the float from moving properly. The seats are attached with separate fasteners adding to the cost and complexity of fabrication. Several parts are required to join the two bodies together, such as a cover and a pipe nipple, adding to the cost and complexity of fabrication. Separate small screens are used inside the housing bodies, which allow debris to enter the bodies and potentially clog the small screens.

A need exists for an improved and less costly liquid flow system capable of protecting piping systems in all environments from adverse pressure conditions and the entrance of external liquids. Further, because of the critical application of the system, a provision for field-testing is needed.

### SUMMARY OF THE INVENTION

The present invention provides a system and a method including an air/vacuum valve, air release valve or combination-type air valve having a liquid flow control device. In addition, the present invention provides a system and a method easily adaptable to any system requiring a liquid flow control device used in conjunction with a length of piping.

To this end, in an embodiment of the present invention, a system is provided for controlling flow of liquid into and within a vent line. The system has a first float in a first body and a second float in a second body. The first body has an open flanged top end, a flanged bottom end formed as an undivided part of said first body with an inlet therethrough and an interior wall defining an open interior. The second body also has an open flanged top end arranged to mate with said flanged bottom end of said first body, a bottom end, an interior wall defining an open interior and an inlet into the open interior. In an embodiment, the first body and the second body are identical in size, shape and configuration.

A cover is arranged to engage the top end of the first body and it has an outlet formed therethrough. A first seat is secured at the outlet in the cover to define an outlet for the first body. A second seat is secured at the inlet of the first body to define an outlet for the second body. The floats are capable of moving into and out of engagement with their respective seats due to a level of liquid in the interior of the respective body.

In an embodiment of the invention at least one of the floats has an elongated shape. In an embodiment of the invention the elongated float has a hemispherical upper end. In an embodiment of the invention the elongated float has a flat top surface.

In an embodiment of the invention a first fastening mechanism securing the flanged top end of the first body to the cover comprises a band clamp engaging the flanged top end of the first body and a flange on the cover.

In an embodiment of the invention a second fastening mechanism securing the flanged top end of the second body to the flanged bottom end of the first body comprises a band clamp engaging the flanged top end of the second body and the flanged bottom end of the first body.

In an embodiment of the invention a plurality of support elements position at least one of the first float and the second float within the interior of the respective body away from the respective inlet and inwardly of the respective interior wall of the respective body.

In an embodiment of the invention the plurality of support elements comprise ribs formed on one of the respective interior wall and the respective float.

In an embodiment of the invention the first seat is captured between the open flanged top end of the first body and the cover where it performs a dual role: it seals the first float and it seals the joint between the first body and the cover.

In an embodiment of the invention the second seat is captured between the open flanged top end of the second body and the flanged bottom end of the first body where it performs a dual role: it seals the second float and it seals the joint between the first body and the second body.

In an embodiment of the invention a screen is provided at the inlet of the second body and a fastening mechanism is provided between the screen and the second body. In an embodiment, the screen has a flange and the fastening mechanism comprises a band clamp engaging the flange of the screen and a flange of the bottom end of the second body. In an embodiment, a bayonet connection is provided between the screen and the second body.

Other details of embodiments of the present invention are illustrated in the drawings and described below.

### BRIEF DESCRIPTION OF THE DRAWINGS

FIG. 1 illustrates a cross-sectional view of a liquid pipeline system including a liquid flow control system embodying the principles of the present invention.

FIG. 2 illustrates a cross-sectional detailed view of an embodiment of the liquid flow control system of the present invention.

FIG. 3 illustrates a cross-sectional detailed view of another embodiment of the liquid flow control system of the present invention.

FIG. 4 illustrates an elevational view of an embodiment of a float used with the liquid flow control system of the present invention.

FIG. 5 illustrates an elevational view of another embodiment of a float used with the liquid flow control system of the present invention.

FIG. 6 illustrates a partial cross-sectional view of another embodiment of a liquid flow control system of the present invention.

FIG. 7 illustrates a partial elevational view of a fastening mechanism between a second body and a screen.

### DETAILED DESCRIPTION OF THE PREFERRED EMBODIMENTS

The present invention generally relates to a system for exhausting and emitting air when installed on water and waste handling pipelines and/or piping systems. A primary function of such air/vacuum valves, air release valves and combination-type air valves is to prevent air and/or vacuum related problems within a liquid pipeline. The system includes a liquid flow device to control or prevent entrance of water into the pipeline when the area surrounding the system is flooded.

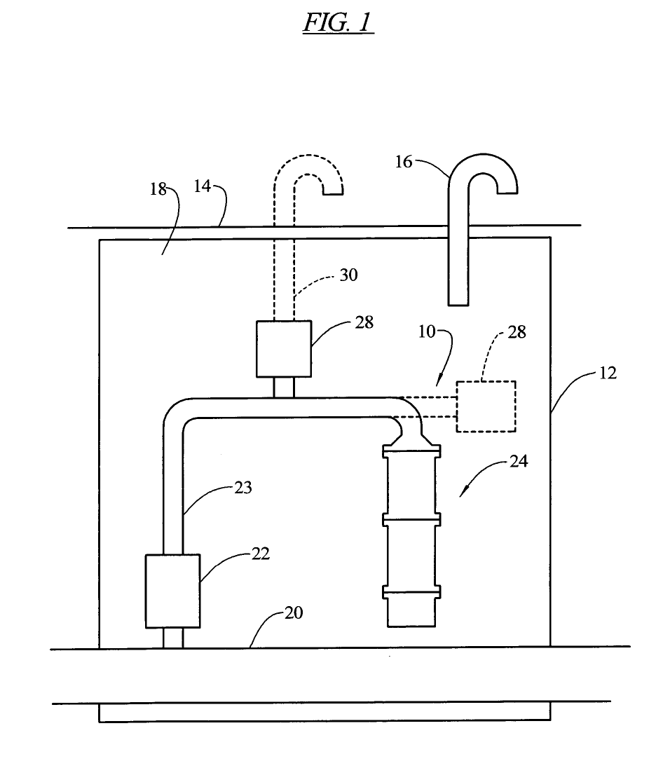

Referring now to FIG. 1, a general arrangement of a system 10 utilizing the present invention is illustrated. The system 10 is positioned within a vault 12 that is buried below a surface grade 14. The vault 12 includes a vent pipe 16 to allow an inflow and outflow of air relative to an interior 18 of the vault. Typically the interior 18 of the vault 12 is accessible through a removable manhole cover or the like (not shown). A pipeline 20 extends through the vault 12 which may be used to transport potable water, wastewater, and other liquids. In order to prevent damage to the pipeline 20, it is customary to provide an air valve 22 in a vent line 23, as discussed in U.S. Pat. No. 5,613,513, which is incorporated herein by reference. Generally, the air valve 22 allows for a flow of air into and out of the pipeline 20 as required by the pressures in the pipeline, but prevents a flow of liquid from leaving the pipeline. When the pressure in the pipeline 20 is low, that is, below atmospheric pressure, air from the interior of the vault 12 is allowed to be drawn into the pipeline 20 through the air valve 22 and vent line 23. To prevent ground water or other contaminating liquids into the pipeline 20, a system 24 for controlling a flow of liquid is connected to the vent line 23, which leads to the air valve 22. The air valve 22 is positioned in the vent line 23 between the pipeline 20 and the liquid flow control system 24 so that the liquid control system allows for a flow of air into and out of the vent line, but prevents a flow of liquid from the interior 18 of the vault 12 into the vent line. That is, if the interior 18 of the vault 12 fills with water or other liquid to a level, which would otherwise include an open end of the vent line 23, the liquid flow control system 24 would prevent that liquid from entering the vent line.

In order to prevent damage to the pipeline 20 when a below atmospheric (vacuum) condition of a predetermined magnitude exists in the pipeline and the vault 12 is filled with a liquid above the inlet for the pipe 26, a vacuum breaker valve 28 may be positioned in the vent line 23 between the air valve 22 and the liquid flow control system 24. The vacuum breaker valve 28 may be positioned higher in the vault 12 than the liquid flow control system 24 to allow for a greater amount of liquid to have to fill the vault before contamination of the pipeline 20 would occur, or the vacuum breaker valve optionally may be provided with a vent pipe 30 leading out of the vault and above the grade level 14 to provide a still greater margin against contamination of the pipeline. The vacuum breaker valve 28, which may be preset to open at a certain critical vacuum pressure, may be of any standard design, such as the Vacuum Breaker 1800VB sold by Val-Matic Valve and Manufacturing Corp. of Elmhurst, Ill. An alternative position for the vacuum breaker valve 28 is shown by dashed lines, such that it is in fluid communication with the vent line 23, in a different branch of the vent line than the liquid flow control system 24.

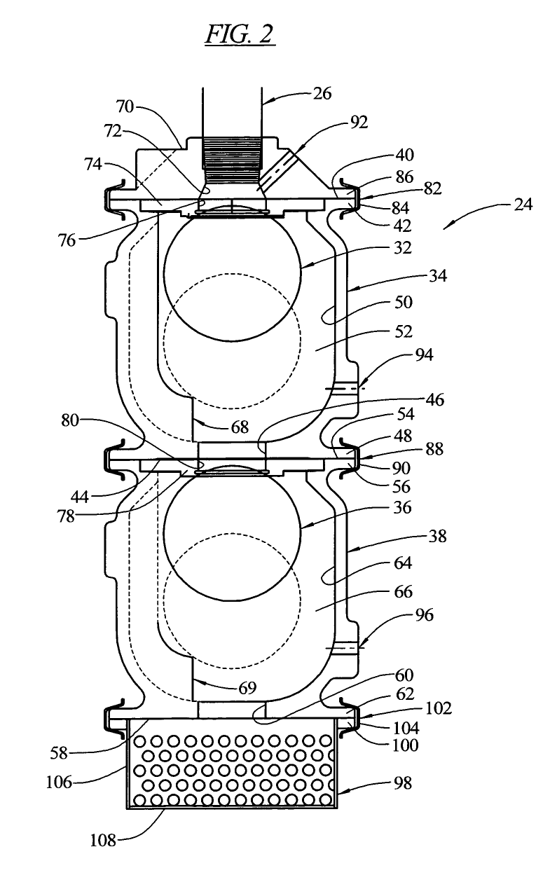

Various embodiments and details of the improved liquid flow control system 24 are illustrated in FIGS. 2-6.

In FIG. 2, an embodiment of the liquid flow control system 24 is shown being connected to the pipe 26. The liquid flow control system 24 includes a first float 32 in a first body 34 and a second float 36 in a second body 38. The first body 34 has an open top end 40 which may include a flange 42 and a bottom end 44 with an inlet 46 therethrough. The bottom end 44 may also have a flange 48. In embodiments where the bottom end 44 has the flange 48, the flange may form an undivided part of the first body 34, such that the flange and the body are formed as a single unitary member, and no connections or seals are required to join the flange to the body. The first body 34 includes an interior wall 50 defining an open interior 52. The second body 38 also has an open top end 54 which may include a flange 56, which is arranged to mate with the bottom end 44 of the first body 34. The second body 38 also includes a bottom end 58 which may include an inlet 60 therethrough. The bottom end 58 may also have a flange 62. In embodiments where the bottom end 58 has the flange 62, the flange may form an undivided part of the second body 38, such that the flange and the body are formed as a single unitary member, and no connections or seals are required to join the flange to the body. The second body 38 includes an interior wall 64 defining an open interior 66. The inlet 60 may be positioned at a location other than the bottom end 58, so long as it provides an inlet to the open interior. In an embodiment, the first body 34 and the second body 38 are identical in size, shape and configuration.

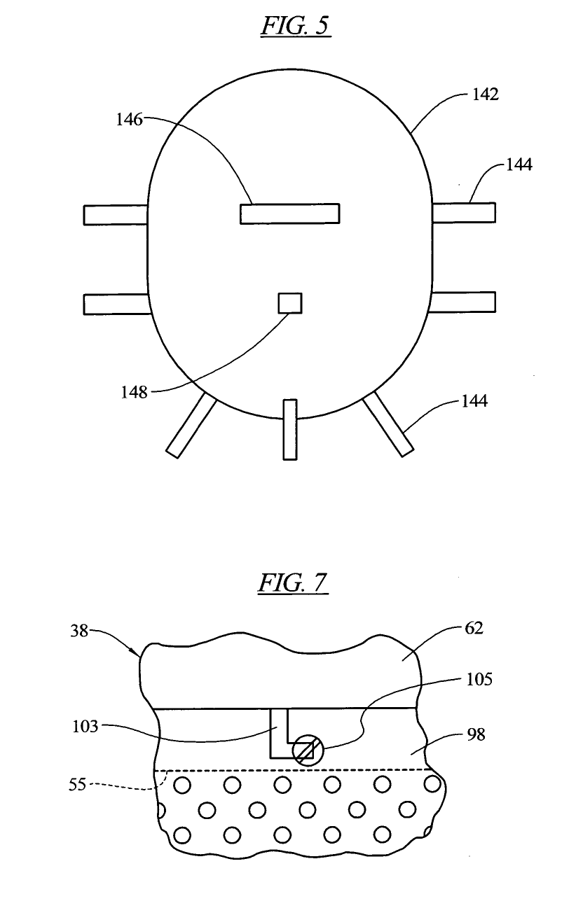

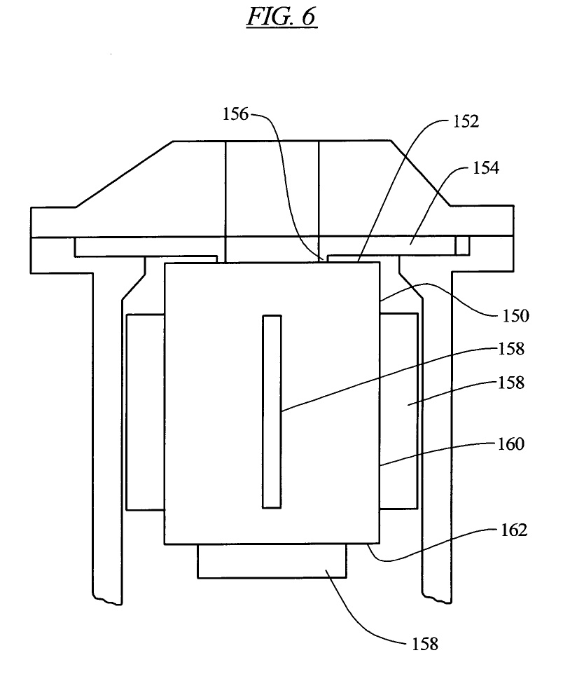

In an embodiment of the invention as shown in FIG. 2, a plurality of support elements 68 position the first float 32 within the interior 52 of the first body 34 above the inlet 46 and inwardly of the interior wall 50 of the first body. A plurality of support elements 69 are used to position the second float 36 within the interior 66 of the second body 38 away from the inlet 60 and inwardly of the interior wall 64 of the second body. In the embodiment illustrated in FIG. 2, the support elements 68, 69 comprise a plurality of ribs (such as 3) formed on the interior wall 50 of the first body 34. The support elements 68, 69 may be a plurality of single ribs extending vertically and horizontally, as shown, or may be segmented to have vertical components along the side walls 50, 64 and horizontal components near the bottom ends 44, 58 of the bodies 34, 38. The use of the support elements 68, 69 will assure that the first float 32 will not seal closed the inlet 46, and that the second float 36 will not seal closed the inlet 60, thereby assuring a free flow of air into and out of the inlets. The support elements 68 also guide the floats 32, 36 in the center of their respective bodies 34, 38 and their seat openings as described below. Other types of support elements 68 are shown and described below with respect to FIGS. 5 and 6.

In the embodiment illustrated in FIG. 2, the floats 32, 36 have a spherical shape, although other shapes and configurations, as shown and described below with respect to FIG. 6, could be utilized.

A cover 70 is arranged to engage the top end 40 of the first body 34 and it has an outlet 72 formed therethrough. A first seat 74 is secured at the outlet 72 in the cover 70 to define an outlet for the first body 34. The first seat 74 may be in the form of a disk formed from a resilient elastomeric material having a passage 76 therethrough to align with the outlet 72 in the cover. The first seat 74 may, for example, be of the type shown and described in FIGS. 5-7 of U.S. Pat. No. 5,769,429, which is incorporated herein by reference. In the embodiment of the invention illustrated in FIG. 2, the first seat 74 is captured between the open flanged top end 40 of the first body 34 and the cover 70. In this manner, no separate fastening elements are required to maintain the seat in its proper orientation within the first body 34 and no separate gasket is required to seal the first body 34 to the cover 70.

A second seat 78 is secured at the inlet 46 of the first body 34 to define an outlet for the second body 38. The second seat 78 may be in the form of a disk formed from a resilient elastomeric material having a passage 80 therethrough to align with the inlet 46 in the first body 34. The second seat 78 may, for example, be of the type shown and described in FIGS. 5-7 of U.S. Pat. No. 5,769,429. In the embodiment of the invention illustrated in FIG. 2, the second seat 78 is captured between the open flanged top end 54 of the second body 38 and the flanged bottom end 44 of the first body 34. In this manner, no separate fastening elements are required to maintain the seat in its proper orientation within the second body 38 and no separate gasket is required to seal the second body 38 to the first body 34.

The floats 32, 36 are capable of moving into and out of sealing engagement with their respective seats 74, 78 due to a level of liquid in the interior of the respective body 34, 38.

In the embodiment of the invention shown in FIG. 2, a first fastening mechanism 82 is used to secure the flanged top end 40 of the first body 34 to the cover 70. In this embodiment, the first fastening mechanism 82 comprises a band clamp 84 engaging the flange 42 of the top end 40 of the first body 34 and a flange 86 on the cover 70. The band clamp 84 may be generally of the types disclosed in U.S. Pat. No. 6,877,780 or 5,909,904 (V band 20), both of which are incorporated herein by reference.

In the embodiment of the invention shown in FIG. 2, a second fastening mechanism 88 is used to secure the flanged top end 54 of the second body 38 to the flanged bottom end 44 of the first body 34. In this embodiment, the second fastening mechanism 88 comprises a band clamp 90 engaging the flange 56 of the top end 54 of the second body 38 and the flange 48 of the bottom end 44 of the first body 34. The band clamp 90 may also be of the same type as described above.

In the embodiment of the invention shown in FIG. 2, the cover 70, the first body 34 and the second body 38 are provided with test ports 92, 94, 96. With the inlet 60 of the second body 38 temporarily plugged, a test fluid, such as water, may be pumped into the second body interior 66 to test whether the second float 36 will properly rise and seal against the second seat 78 while the test port 94 in the first body is open. If the test fluid begins to come out of the test port 94, then a complete seal will not have been achieved, but if no test fluid emerges, then the seal is complete. Test fluid may also be pumped into the first body interior 52 with the test port 92 in the cover open to test whether the first float 32 will properly rise and seal against the first seat 74. Again, if the test fluid begins to come out of the test port 92, then a complete seal will not have been achieved, but if no test fluid emerges, then the seal is complete.

In the embodiment of the invention shown in FIG. 2, a screen 98 is provided at the inlet 60 of the second body 38. The screen 98 may have a flange 100 and a fastening mechanism 102 comprising a band clamp 104 may engage the flange 100 of the screen and the flange 62 of the bottom end 58 of the second body 38. Alternatively, the screen 98 may be attached directly to the flange 62 of the bottom end 58 of the second body 38, such as with threaded fasteners, or with a threaded connection, or with a bayonet type connection (a dog-leg slot 103 in the screen and a threaded fastener 105) as illustrated in the partial view of FIG. 7, or other known connection arrangements. The screen 98 is shown as including a perforated circumferential wall 106 as well as a perforated bottom wall 108 to provide a large inlet area with reduced possibility for blockage, although smaller screens may be used, such as a flat screen bridging the opening of the inlet 60. As a further alternative, the side wall 64 of the second body 38 may be perforated such that part of, or all of, the second body acts as a screen. A different seal testing procedure would need to be employed for the second seat 78, such as submerging at least the second body 38 and its connection to the first body 34, if test ports 92, 94 are provided.

The bodies 34, 38, cover 70 and screen 98 may have a circular horizontal cross section, or they may have other shapes, such as square or rectangular.

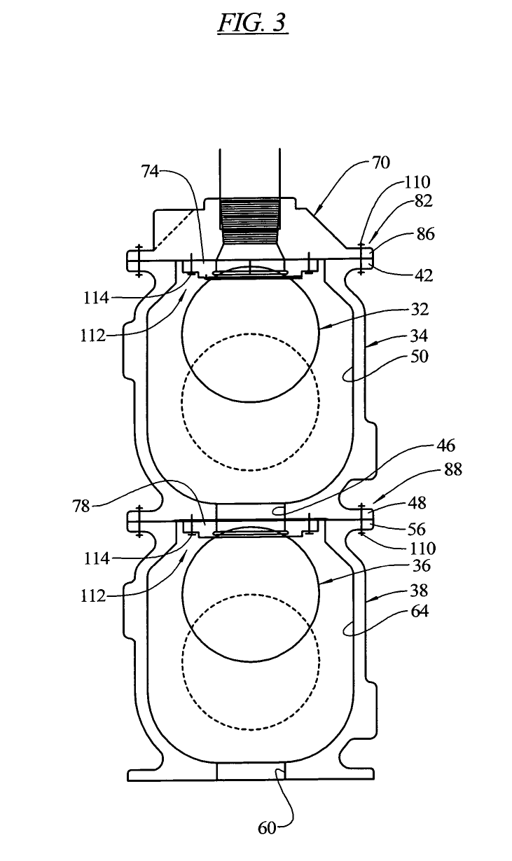

An alternative embodiment of the invention is illustrated in FIG. 3, which has some variations over the embodiment illustrated in FIG. 2, although many components appear the same, and will be referenced with the reference numbers used in FIG. 2.

One of the differences shown in FIG. 3 is that the first fastening mechanism 82 and the second fastening mechanism 88 are illustrated as a screw or bolt 110 extending through the flanges 42, 86 and 48, 56. A second difference is that no support elements 68, 69 are shown or provided for the floats 32, 36. In this embodiment, the floats 32, 36 may rest on their respective inlets 46, 60, which will require that some pressure above atmospheric exist at the inlets 60, 46 in order to overcome the weight of the floats to allow air to flow into the bodies 34, 38. However, it is preferred to provide support elements on the bodies as described above or on the floats themselves, as discussed below with respect to FIGS. 5 and 6.

Another difference with respect to the embodiment shown in FIG. 3 is that the seats 74, 78 are not clamped between the flanges 86, 42 of the cover 70 and first body 34 or the flanges 54, 56 of the first body and the second body 38. Rather, the seats 74, 78 are secured to the cover 70 and the first body 34 by attachment mechanisms 112 such as threaded fasteners 114.

Another difference with respect to the embodiment shown in FIG. 3 is that the test ports 92, 94, 96 are not provided in the cover 70, the first body 34 or the second body 38, since those features are optional and provide an enhancement to the basic operation of the system 24.

Another difference with respect to the embodiment shown n FIG. 3 is that the screen 98 is not provided at the inlet 60 of the second body 38. Again, this feature provides an enhancement to the basic operation of the system 24.

Each of the differences between the embodiments of FIG. 1 and FIG. 2 could be used singly or in various combinations in different embodiments of a system that would incorporate the present invention. Other differences are available as described as follows:

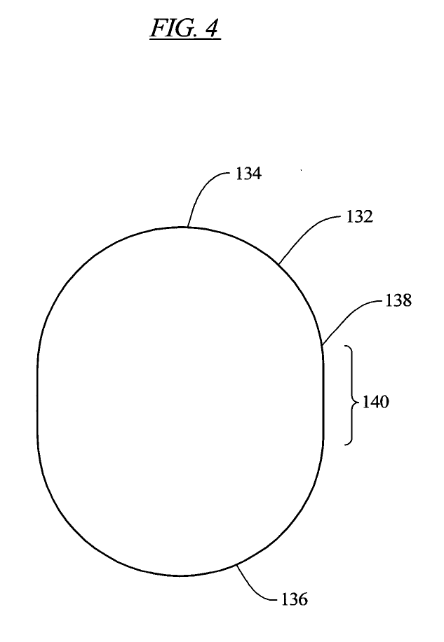

In FIG. 4 an alternate embodiment of a float 132 is shown, wherein the float has an elongated shape. A top end 134 of the float 132 is hemispherical in shape, as is a bottom end 136. A side wall 138 has a linear segment 140 giving the float 132 the elongated shape. An advantage of using a float of this configuration, is that the top end 134 will always remain oriented upwardly in that the elongated shape prevents the float 132 from turning around a horizontal axis while in the body. As the float 132 moves around in the body, due to air flows through the body, and occasional liquid flows, the float may strike interior parts of the body, such as the support elements 68, 69, which cause surface damage, such as dents or scrapes, to the float. If such damage were to occur in an area that later is to abut against the seat 74, 78, a good seal may not result, thus causing leakage. With a perfectly spherical float, the float could rotate around any axis, and thus any portion of the surface could strike any portion of the interior of the body, and could later be the same portion that is to engage the seat. However, with a float having an elongated shape, the top hemispherical end 134 will always be pointed upwardly, and will not be able to engage the support elements 68, 69, so damage in that area will not result.

In FIG. 5, an alternate embodiment of a float 142 is shown, wherein the float again has an elongated shape, and is also provided with support elements 144 protruding therefrom. The support elements 144 may be in the form of ribs protruding from the outer surface of the float 142. The support elements may be elongated along the surface, such as support element 146, or may be a short rib, having a similar sized length and a width at the surface, such as support element 148.

In FIG. 6, an alternate embodiment of a float 150 is shown, wherein the float has a flat top surface 152 arranged to engage with a seat 154 having a sealing bead 156 engaged by the float. The float 150 is provided with support elements 158 extending from side 160 and bottom 162 surfaces of the float. Although the support elements 158 are shown as ribs having a vertical elongated shape, they could also have a horizontal elongated shape support element 146 in FIG. 5, or a finger-like shape, such as support element 148 in FIG. 5.

Alternatively, the outer surface of the float 150 may be shaped so as to provide the function of the support elements. For example, if the float 150 is to be used in a body that has a cylindrical shape, then the float could be provided with a square, rectangular or star shaped horizontal cross section, such that the vertical corners of the float would function as support surfaces. On the other hand, if the float 159 is to be used in a body that has a square or rectangular cross sectional shape, then the float could be formed as a cylinder, so that the inside corners between the float and the interior walls of the body would allow passage of air around the cylinder, a function otherwise provided by the support surfaces.

Although a preferred embodiment of the present invention has been described with reference to FIGS. 1 and 2, it should be understood that different shapes of the float rather than the spherical float illustrated may be implemented by those skilled in the art. Also, selections for the material of the float and screen modifications, such as location of screen, type of screen and the like, may be made by a skilled practitioner. What is important is that the density of the float must be less than the density of the activating fluid, yet must be greater than the density of the fluid which is to be allowed to pass the float unrestricted.

Although the primary use of the present invention is within water and waste water piping/pipeline systems, the present invention may be implemented within a variety of applications in which liquid flow control may be required.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for controlling a flow of liquid comprising:
a first float;
a first body;
said first body having an open flanged top end, a flanged bottom end with an inlet therethrough formed as an undivided part of said first body and an interior wall defining an open interior;
said first float being arranged within said open interior of said first body;
a cover arranged to engage said top end of said first body and having an outlet formed therethrough;
a first seat secured at said outlet in said cover to define an outlet for said first body, wherein said first float is capable of moving into and out of engagement with said first seat due to a level of liquid in said interior of said first body;
a second float;
a second body;
said second body having an open flanged top end arranged to mate with said flanged bottom end of said first body, a bottom end, an interior wall defining an open interior and an inlet into said open interior;
a second seat secured at said inlet of said first body to define an outlet for said second body, wherein said second float is capable of moving into and out of engagement with said second seat due to a level of liquid in said interior of said second body.

2. A system according to claim 1, wherein at least one of said floats has an elongated shape.

3. A system according to claim 2, wherein said elongated float has a hemispherical upper end.

4. A system according to claim 2, wherein said elongated float has a flat top surface.

5. A system according to claim 1 including a first fastening mechanism securing said flanged top end of said first body to said cover comprising a band clamp engaging said flanged top end of said first body and a flange on said cover.

6. A system according to claim 1 including a second fastening mechanism securing said flanged top end of said second body to said flanged bottom end of said first body comprising a band clamp engaging said flanged top end of said second body and said flanged bottom end of said first body.

7. A system according to claim 1 including a plurality of support elements positioning at least one of said first float and said second float within said interior of said respective body away from said respective inlet and inwardly of said respective interior wall of said respective body.

8. A system according to claim 7, wherein said plurality of support elements comprise ribs formed on one of said respective interior wall and said respective float.

9. A system according to claim 1, wherein said first seat is captured between said open flanged top end of said first body and said cover.

10. A system according to claim 1, wherein said second seat is captured between said open flanged top end of said second body and said flanged bottom end of said first body.

11. A system according to claim 1, wherein said first body and said second body have an identical size, shape and configuration.

12. A system according to claim 1 further comprising a screen at said inlet of said second body, wherein said inlet is located in said bottom end of said second body and said screen has a flange and including a fastening mechanism comprising a band clamp engaging said flange of said screen and a flange of said bottom end of said second body.

13. A system according to claim 1 further comprising a screen at said inlet of said second body, wherein said inlet is located in said bottom end of said second body, including a fastening mechanism comprising a plurality of slots formed in said screen and plurality of threaded fasteners securing said screen to said bottom end of said second body.

14. A system according to claim 1, for use with a liquid pipeline having a vent line extending from said pipeline and being in fluid communication with said cover outlet, further including a vacuum breaker valve in fluid communication with said vent line, and an air flow valve positioned in said vent line between said cover outlet and said pipeline and between said vacuum breaker valve and said pipeline.

15. A system for controlling a flow of liquid comprising:
a first float;
a first body;
said first body having an open top end, a flanged bottom end with an inlet therethrough and an interior wall defining an open interior;
said first float being arranged within said open interior of said first body;
a cover arranged to engage said top end of said first body and having an outlet formed therethrough;
a first seat captured between said open top end of said first body and said cover to define an outlet for said first body, wherein said first float is capable of moving into and out of engagement with said first seat due to a level of liquid in said interior of said first body.

16. A system according to claim 15, further including:
a second float;
a second body;
said second body having an open flanged top end arranged to mate with said flanged bottom end of said first body, a bottom end, an interior wall defining an open interior and an inlet into said open interior;
a second seat captured between said open top end of said second body and said bottom end of said first body to define an outlet for said second body, wherein said second float is capable of moving into and out of engagement with said second seat due to a level of liquid in said interior of said second body.

17. A system according to claim 16, wherein at least one of said floats has an elongated shape.

18. A system according to claim 17, wherein said elongated float has a hemispherical upper end.

19. A system according to claim 17, wherein said elongated float has a flat top surface.

20. A system according to claim 15 including a first fastening mechanism comprising a band clamp engaging a flanged top end of said first body and a flange on said cover.

21. A system according to claim 16 including a second fastening mechanism comprising a band clamp engaging said flanged top end of said second body and said flanged bottom end of said first body.

22. A system according to claim 16 including a plurality of support elements positioning at least one of said first float and said second float within said interior of said respective body away from said respective inlet and inwardly of said respective interior wall of said respective body.

23. A system according to claim 22, wherein said plurality of support elements comprise ribs formed on one of said respective interior wall and said respective float.

24. A system according to claim 16 further comprising a screen at said inlet of said second body.

25. A system according to claim 24, wherein said inlet of said second body is in said bottom end of said second body and said screen has a flange and including a fastening mechanism comprising a band clamp engaging said flange of said screen and a flange of said bottom end of said second body.

26. A system according to claim 24, wherein said inlet of said second body is in said bottom end of said second body and including a fastening mechanism comprising a plurality of slots formed in said screen and a plurality of threaded fasteners securing said screen to said bottom end of said second body.

27. A system according to claim 15, for use with a liquid pipeline having a vent line extending from said pipeline and being in fluid communication with said cover outlet, further including a vacuum breaker valve in fluid communication with said vent line, and an air flow valve positioned in said vent line between said cover outlet and said pipeline and between said vacuum breaker valve and said pipeline.

28. A system for controlling a flow of liquid comprising:
a first float;
a first body;
said first body having an open flanged top end, a flanged bottom end with an inlet therethrough and an interior wall defining an open interior, with a test port formed in said body extending through said interior wall;
said first float being arranged within said open interior of said first body;
a cover with a peripheral flange arranged to engage said top end of said first body having an outlet formed therethrough and a test port formed therethrough;
a first seat captured between said open top end of said first body and said cover to define an outlet for said first body, wherein said first float is capable of moving into and out of engagement with said first seat due to a level of liquid in said interior of said first body;
a first fastening mechanism comprising a band clamp engaging said flanged top end of said first body and said flange on said cover;
a second float;
a second body;
said second body having an open flanged top end arranged to mate with said flanged bottom end of said first body, a bottom end with an inlet therethrough and an interior wall defining an open interior, with a test port formed in said body extending through said interior wall;
a second seat captured between said open top end of said second body and said bottom end of said first body to define an outlet for said second body, wherein said second float is capable of moving into and out of engagement with said second seat due to a level of liquid in said interior of said second body;
a second fastening mechanism comprising a band clamp engaging said flanged top end of said second body and said flanged bottom end of said first body; and
a screen at said inlet of said second body,
a fastening mechanism arranged between said screen and said second body.

29. A system according to claim 28, wherein said inlet of said second body is at said bottom end of said second body and said fastening mechanism comprises a band clamp engaging a flange of said flange of said screen and a flange of said bottom end of said second body.

30. A system according to claim 28, wherein said inlet of said second body is at said bottom end of said second body and said fastening mechanism comprises a plurality of slots formed in said screen and a plurality of threaded fasteners securing said screen to said bottom end of said second body.

31. A system according to claim 28, wherein at least one of said floats has an elongated shape.

32. A system according to claim 31, wherein said elongated float has a hemispherical upper end.

33. A system according to claim 31, wherein said elongated float has a flat top surface.

34. A system according to claim 28 including a plurality of support elements positioning at least one of said first float and said second float within said interior of said respective body away from said respective inlet and inwardly of said respective interior wall of said respective body.

35. A system according to claim 34, wherein said plurality of support elements comprise ribs formed on said respective interior wall.

36. A system according to claim 28, for use with a liquid pipeline having a vent line extending from said pipeline and being in fluid communication with said cover outlet, further including a vacuum breaker valve in fluid communication with said vent line, and an air flow valve positioned in said vent line between said cover outlet and said pipeline and between said vacuum breaker valve and said pipeline.
